(19) United States
(12) Patent Application Publication
(10) Pub. No.: US 2026/0149795 A1
(43) Pub. Date: May 28, 2026

(54) DEVICE AND METHOD FOR MEASURING TILT ANGLE USING MULTI-ZONE TIME-OF-FLIGHT MODULE

(71) Applicant: STMicroelectronics International N.V., Geneva (CH)

(72) Inventors: Xingyu WANG, Shenzhen (CN); Zhiyuan HAN, Beijing (CN); Jinan LI, SHENZHEN (CN); Lizhen ZHANG, Shenzhen (CN)

(21) Appl. No.: 18/960,709

(22) Filed: Nov. 26, 2024

(51) Int. Cl. H04N 9/31; G01S 7/48; G01S 17/08; G01S 17/89

(52) U.S. Cl. CPC H04N 9/3185; G01S 7/4802; G01S 17/08; G01S 17/89; H04N 9/3194

(57) ABSTRACT

In accordance with various embodiments of the present disclosure, a device comprises a time-of-flight (Tof) sensor and a controller. The ToF sensor determines a distance to a surface for a plurality of different zones arranged in a distance matrix. The controller is configured to (i) receive the distance matrix, (ii) create a horizontal tilt axis matrix, where each row comprises a plurality of horizontal tilt angles, each calculated using two adjacent distances in a corresponding row of the distance matrix, (iii) create a vertical tilt axis matrix, where each column comprises a plurality of vertical tilt angles, each calculated using two adjacent distances in a corresponding column of the distance matrix, (iv) calculate an average of the horizontal tilt angles for horizontal tilt angle correction, and (v) calculate an average of the vertical tilt angles for vertical tilt angle correction.

### FIELD OF THE INVENTION

Example embodiments of the present disclosure relate generally to time-of-flight sensing and, more specifically, to using time of flight sensing in autofocus control of image projection devices.

### BACKGROUND

Portable projectors are often used to project images, video, presentations, etc. from computers, tablets, mobile phones, etc. onto surfaces such as projector screens or often just blank walls (these surfaces may be termed “projection surfaces”. Because such a projector is portable, the projector will likely not be positioned perfectly perpendicularly to the wall. For example, the projector may be angled upward or downward and/or leftward or rightward of the perfectly perpendicular location. Such an angled projection, if left uncorrected, will cause a distortion in the projected images.

For example, FIG. 1 shows what are termed “keystone” distortions that results when the projector is angled. FIG. 1 illustrates vertical keystone distortions that result when the projector is angled downward or upward, and horizontal keystone distortions that result when the projector is angled leftward or rightward.

Such keystone distortions can be corrected by the projector software if the projector's angle relative to the wall (termed the “tilt angle) is determined. The more accurately the tilt angle is determined, the more accurate the keystone correction is.

Applicant has identified many technical challenges and difficulties associated with determining the tilt angle of projection devices. Through applied effort, ingenuity, and innovation, Applicant has solved problems related to determining the tilt angle of projection devices by developing solutions embodied in the present disclosure, which are described in detail below.

### BRIEF SUMMARY

Various embodiments described herein related to devices and methods for determining a tilt angle of a device having a time-of-flight (Tof) sensor.

In accordance with various embodiments of the present disclosure, a device comprises a time-of-flight (Tof) sensor and a controller. The ToF sensor determines a distance from the ToF sensor to a surface for a plurality of different zones arranged in a distance matrix of m rows. The controller is configured to (i) receive the distance matrix from the ToF sensor, (ii) create a horizontal tilt axis matrix of m rows and (n−1) columns, where each row of the horizontal tilt axis matrix comprises a plurality of horizontal tilt angles, each calculated using two adjacent distances in a corresponding row of the distance matrix, (iii) create a vertical tilt axis matrix of (m−1) rows and n columns, where each column of the vertical tilt axis matrix comprises a plurality of vertical tilt angles, each calculated using two adjacent distances in a corresponding column of the distance matrix, (iv) calculate an average of the plurality of horizontal tilt angles in the horizontal tilt axis matrix to be used for horizontal tilt angle correction, and (v) calculate an average of the plurality of vertical tilt angles in the vertical tilt axis matrix to be used for vertical tilt angle correction.

In some embodiments, the controller is further configured to receive a confidence indicator for each distance in the distance matrix. The controller does not use any distance in the distance matrix for which the confidence indicator indicates a lack of confidence when calculating any of the plurality of horizontal tilt angles, any of the plurality of vertical tilt angles, the average of the plurality of horizontal tilt angles in the horizontal tilt axis matrix, or the average of the plurality of vertical tilt angles in the vertical tilt axis matrix.

In some embodiments, if the distance in a leftmost cell of each row of the distance matrix is greater than the distance in every other cell in a same row of the distance matrix, the controller does not use any distances in a leftmost column of the distance matrix when calculating any of the plurality of horizontal tilt angles, any of the plurality of vertical tilt angles, the average of the plurality of horizontal tilt angles in the horizontal tilt axis matrix, or the average of the plurality of vertical tilt angles in the vertical tilt axis matrix. If the distance in a rightmost cell of each row of the distance matrix is greater than the distance in every other cell in a same row of the distance matrix, the controller does not use any distances in a rightmost column of the distance matrix when calculating any of the plurality of horizontal tilt angles, any of the plurality of vertical tilt angles, the average of the plurality of horizontal tilt angles in the horizontal tilt axis matrix, or the average of the plurality of vertical tilt angles in the vertical tilt axis matrix. If the distance in a topmost cell of each column of the distance matrix is greater than the distance in every other cell in a same column of the distance matrix, the controller does not use any distances in a topmost row of the distance matrix when calculating any of the plurality of horizontal tilt angles, any of the plurality of vertical tilt angles, the average of the plurality of horizontal tilt angles in the horizontal tilt axis matrix, or the average of the plurality of vertical tilt angles in the vertical tilt axis matrix. If the distance in a bottommost cell of each column of the distance matrix is greater than the distance in every other cell in a same column of the distance matrix, the controller does not use any distances in a bottommost row of the distance matrix when calculating any of the plurality of horizontal tilt angles, any of the plurality of vertical tilt angles, the average of the plurality of horizontal tilt angles in the horizontal tilt axis matrix, or the average of the plurality of vertical tilt angles in the vertical tilt axis matrix.

In some embodiments, the controller does not use any distances in a topmost row or in the two topmost rows of the distance matrix when calculating any of the plurality of horizontal tilt angles, any of the plurality of vertical tilt angles, the average of the plurality of horizontal tilt angles in the horizontal tilt axis matrix, or the average of the plurality of vertical tilt angles in the vertical tilt axis matrix.

In some embodiments, the controller is further configured to determine if the average of the plurality of horizontal tilt angles in the horizontal tilt axis matrix is within a predefined range of zero degrees. If the average of the plurality of horizontal tilt angles in the horizontal tilt axis matrix is within the predefined range of zero degrees, the controller is further configured to recalculate the average of the plurality of horizontal tilt angles in the horizontal tilt axis matrix without using any distance in peripheral cells of the distance matrix. The controller is further configured to determine if the average of the plurality of vertical tilt angles in the vertical tilt axis matrix is within a predefined range of zero degrees. if the average of the plurality of vertical tilt angles in the vertical tilt axis matrix is within the predefined range of zero degrees, the controller is further configured to recalculate the average of the plurality of vertical tilt angles in the vertical tilt axis matrix without using any distance in peripheral cells of the distance matrix.

In some embodiments, the controller is further configured to determine an estimated perpendicular distance from the ToF sensor to the surface. The controller is further configured to determine which one of a plurality of predetermined gain coefficients corresponds to the determined estimated perpendicular distance from the ToF sensor to the surface. The controller is further configured to multiply the calculated average of the plurality of horizontal tilt angles in the horizontal tilt axis matrix by the one of the plurality of predetermined gain coefficients. The controller is further configured to multiply the calculated average of the plurality of vertical tilt angles in the vertical tilt axis matrix by the one of the plurality of predetermined gain coefficients.

In some embodiments, the Tof sensor determines the distance from the ToF sensor to the surface for the plurality of different zones and the controller (i) receives the distance matrix from the ToF sensor, (ii) creates the horizontal tilt axis matrix, (iii) creates the vertical tilt axis matrix, (iv) calculates the average of the plurality of horizontal tilt angles in the horizontal tilt axis matrix, and (v) calculates the average of the plurality of vertical tilt angles in the vertical tilt axis matrix upon startup of the device.

In some embodiments, the device further comprises a motion sensor configured to detect movement of the device. Upon detection of movement by the motion sensor, the Tof sensor is further configured to determine a revised distance from the ToF sensor to the surface for the plurality of different zones and the controller is further configured to (i) receive a revised distance matrix from the ToF sensor, (ii) create a revised horizontal tilt axis matrix of m rows and (n−1) columns, where each row of the horizontal tilt axis matrix comprises a plurality of horizontal tilt angles, each calculated using two adjacent distances in a corresponding row of the distance matrix, (iii) create a revised vertical tilt axis matrix of (m−1) rows and n columns, where each column of the vertical tilt axis matrix comprises a plurality of vertical tilt angles, each calculated using two adjacent distances in a corresponding column of the distance matrix, (iv) calculate a revised average of the plurality of horizontal tilt angles in the horizontal tilt axis matrix to be used for horizontal tilt angle correction, and (v) calculate a revised average of the plurality of vertical tilt angles in the vertical tilt axis matrix to be used for vertical tilt angle correction.

In some embodiments, the Tof sensor determines the distance from the ToF sensor to the surface for the plurality of different zones and the controller (i) receives the distance matrix from the ToF sensor, (ii) creates the horizontal tilt axis matrix, (iii) creates the vertical tilt axis matrix, (iv) calculates the average of the plurality of horizontal tilt angles in the horizontal tilt axis matrix, and (v) calculates the average of the plurality of vertical tilt angles in the vertical tilt axis matrix repeatedly during operation of the device.

In some embodiments, the device comprises a projector.

In accordance with various embodiments of the present disclosure, a method of determining a tilt angle of a device having a time-of-flight (Tof) sensor is provided. In some embodiments, the method comprises receiving a distance matrix from the ToF sensor, the distance matrix comprising a distance from the ToF sensor to a surface for a plurality of different zones arranged in the distance matrix of m rows and n columns; creating a horizontal tilt axis matrix of m rows and (n−1) columns, where each row of the horizontal tilt axis matrix comprises a plurality of horizontal tilt angles, each calculated using two adjacent distances in a corresponding row of the distance matrix; creating a vertical tilt axis matrix of (m−1) rows and n columns, where each column of the vertical tilt axis matrix comprises a plurality of vertical tilt angles, each calculated using two adjacent distances in a corresponding column of the distance matrix; calculating an average of the plurality of horizontal tilt angles in the horizontal tilt axis matrix to be used for horizontal tilt angle correction; and calculating an average of the plurality of vertical tilt angles in the vertical tilt axis matrix to be used for vertical tilt angle correction.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those here summarized, some of which will be further described below.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 illustrates keystone distortions that may be corrected by determining a tilt angle of a device, such as by using embodiments of the present disclosure;

FIG. 2 partially illustrates how a time-of-flight sensor measures distances to a surface to create a distance matrix, in accordance with some embodiments of the present disclosure;

FIG. 3 partially illustrates how a tilt angle is calculated, in accordance with some embodiments of the present disclosure;

FIG. 4 illustrates a distance matrix, a horizontal tilt angle matrix, and a vertical tilt angle matrix, in accordance with some embodiments of the present disclosure;

FIG. 5 illustrates a distance matrix, a horizontal tilt angle matrix, and a vertical tilt angle matrix, in accordance with some alternative embodiments of the present disclosure;

FIGS. 6A-H illustrate distance matrices, horizontal tilt angle matrices, and vertical tilt angle matrices, in accordance with some alternative embodiments of the present disclosure;

FIG. 7 illustrates a horizontal tilt angle matrix and a vertical tilt angle matrix, in accordance with some alternative embodiments of the present disclosure;

FIG. 8 illustrates a distance matrix, a horizontal tilt angle matrix, and a vertical tilt angle matrix, in accordance with some alternative embodiments of the present disclosure; and

FIG. 9 is a block diagram of an example device for determining a tilt angle, in accordance with some embodiments of the present disclosure.

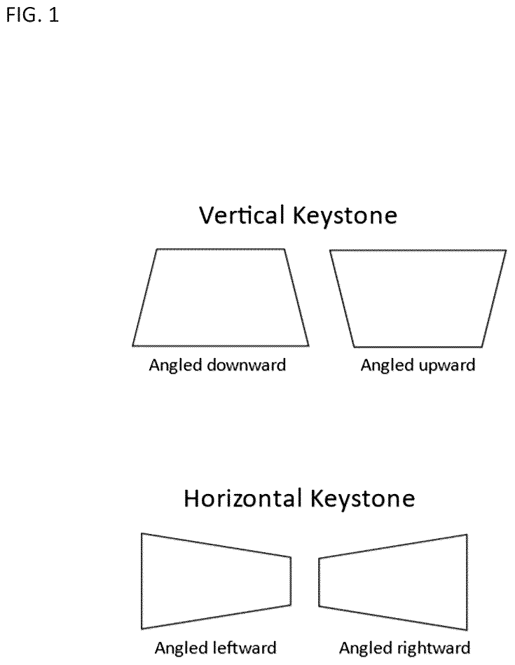

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

Various embodiments of the present disclosure overcome the above technical challenges and difficulties and provide various technical improvements and advantages based on, for example, but not limited to, providing example devices (including but not limited to projectors) and methods for determining a tilt angle using a multi-zone Tof sensor in which distances to a projection surface (e.g., a wall) are determined for each zone, a horizontal tilt angle map and a vertical tilt angle map are calculated using the determined distances, the horizontal tilt angles in the horizontal tilt angle map are averaged to obtain the horizontal tilt angle to be used for horizontal tilt angle correction, and the vertical tilt angles in the vertical tilt angle map are averaged to obtain the vertical tilt angle to be used for vertical tilt angle correction. The value obtained by averaging the horizontal tilt angles in the horizontal tilt angle map may be termed the “overall horizontal tilt angle” and the value obtained by averaging the vertical tilt angles in the vertical tilt angle map may be termed the “overall vertical tilt angle.”

Embodiments of the present disclosure will be described herein in relation to determining the tilt angle of a projector to a projection surface, however, the methods of determining tilt angle of embodiments of the present disclosure may be used with any suitable device. A ToF sensor is a range imaging device for measuring distances between the device and a subject (e.g., a wall) based on the round-trip time of an artificial light signal, such as may be provided by a vertical-cavity surface-emitting laser (VCSEL).

In various embodiments, a column of data from the horizonal tilt angle map is eliminated based on a leftward or rightward tilt and/or a row of data from the vertical tilt angle map is eliminated based on an upward or downward tilt. Then, the remaining horizontal tilt angles in the horizontal tilt angle map are averaged to obtain the horizontal tilt angle to be used for horizontal tilt angle correction, and the remaining vertical tilt angles in the vertical tilt angle map are averaged to obtain the vertical tilt angle to be used for vertical tilt angle correction.

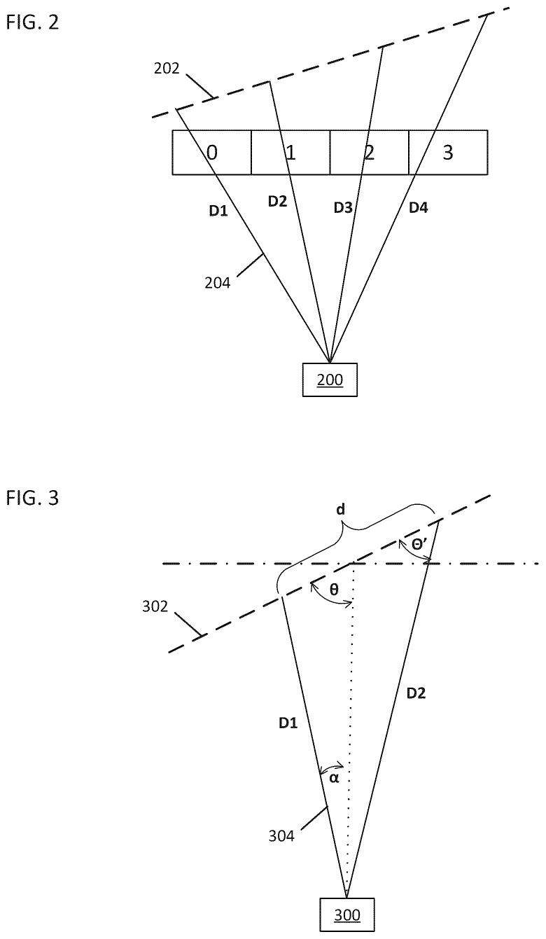

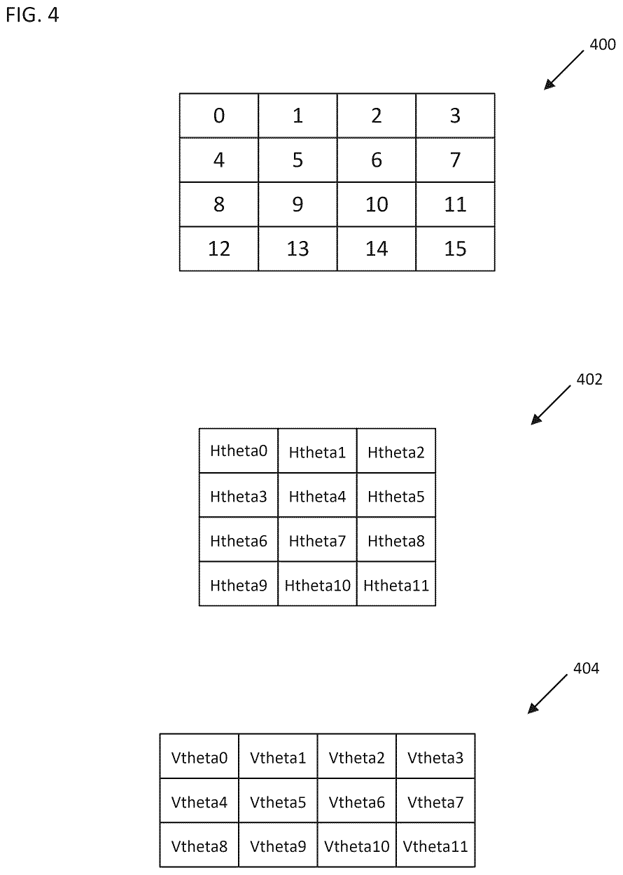

FIG. 2 partially illustrates how a multi-zone ToF sensor measures distances to a projection surface to create a distance matrix, in accordance with some embodiments of the present disclosure. Embodiments of the present disclosure will be described herein in relation to a sixteen zone ToF sensor that directs beam of laser light (e.g., from a VCSEL) in sixteen different directions (corresponding to a 4×4 array) to determine sixteen different distances between the ToF sensor and a surface toward which the device pointed, however, any suitable multi-zone ToF sensor may be used (generically, the distance matrix is expressed as having m rows and n columns). The sixteen different distances are saved in a 4×4 distance matrix. Such a distance matrix 400 (described further below) is illustrated in FIG. 4. As seen in FIG. 4, the distance matrix 400 comprises sixteen cells labeled cell 0 through cell 15.

FIG. 2 illustrates the determination of four of the sixteen distances—D1 through D4—between the projector 200 and a surface 202 (e.g., wall or projection screen at which the projector would be pointed to project images) that a ToF sensor (not separately illustrated) within the projector 200 would determine. The four distances are illustrated in FIG. 2 by the solid lines. As illustrated by FIG. 2, these four distances would each be saved in a separate cell of a distance matrix: distance D1 in cell 0, distance D2 in cell 1, distance D3 in cell 2, and distance D4 in cell 3. Although not shown in FIG. 2, the remaining distances and cells are as follows: distance D5 in cell 4, distance D6 in cell 5, distance D7 in cell 6, distance D8 in cell 7, distance D9 in cell 8, distance D10 in cell 9, distance D11 in cell 10, distance D12 in cell 11, distance D13 in cell 12, distance D14 in cell 13, distance D15 in cell 14, and distance D16 in cell 15.

FIG. 3 illustrates how a tilt angle (which is also termed a “theta” (θ) herein) is calculated, in accordance with some embodiments of the present disclosure. A tilt angle can be determined by knowing any two adjacent distances (e.g., D1 and D2 in FIG. 3) between the projector 300 and the surface 302 in the distance matrix and the bisected value α of the angle between the two beams of laser light that determined the two distances. This bisected value α is a function of the ToF sensor and can be roughly estimated by dividing the ToF's field of view by four (although this value may vary based on the distance between the projector and the projection surface, such that an optional method of adjusting this value is described below). In an example ToF sensor, the field of view is 45 degrees×45 degrees in the horizontal and vertical directions and the estimated value of α is 11.25 degrees.

In various embodiments, the tilt angle θ is determined using the formulas:

$${d}^{2} = D {1}^{2} + D {2}^{2} - 2 D 1 D 2 cos α ;$$

$$cos {θ}^{′} = \frac{D 2 - D 1 cos α}{d} ; and$$

$$θ = {θ}^{′} + α .$$

FIG. 4 illustrates a distance matrix 400, a horizontal tilt angle matrix 402, and a vertical tilt angle matrix 404 in accordance with some embodiments of the present disclosure. As described above, the distance matrix 400 is a 4×4 matrix having sixteen cells labeled 0 through 15. Each of these cells would hold a distance (not illustrated) (typically in millimeters) corresponding to a different direction in which the beam from the ToF was aimed for each different distance determination.

The horizontal tilt angle matrix 402 comprises a 4×3 matrix of tilt angles (thetas) calculated from the distances in a distance matrix (such as the distance matrix 400), labeled Htheta0 to Htheta11. (Generically, if the distance matrix has m rows and n columns, the horizontal tilt angle matrix has m rows and n−1 columns.) In the illustrated embodiment, Htheta0 is the calculated tilt angle between the distance in cell 0 and the distance in cell 1, Htheta1 is the calculated tilt angle between the distance in cell 1 and the distance in cell 2, Htheta2 is the calculated tilt angle between the distance in cell 2 and the distance in cell 3, Htheta3 is the calculated tilt angle between the distance in cell 4 and the distance in cell 5, Htheta4 is the calculated tilt angle between the distance in cell 5 and the distance in cell 6, Htheta5 is the calculated tilt angle between the distance in cell 6 and the distance in cell 7, Htheta6 is the calculated tilt angle between the distance in cell 8 and the distance in cell 9, Htheta7 is the calculated tilt angle between the distance in cell 9 and the distance in cell 10, Htheta8 is the calculated tilt angle between the distance in cell 10 and the distance in cell 11, Htheta9 is the calculated tilt angle between the distance in cell 12 and the distance in cell 13, Htheta10 is the calculated tilt angle between the distance in cell 13 and the distance in cell 14, and Htheta11 is the calculated tilt angle between the distance in cell 14 and the distance in cell 15.

The vertical tilt angle matrix 404 comprises a 3×4 matrix of tilt angles (thetas) calculated from the distances in a distance matrix (such as the distance matrix 400), labeled Vtheta0 to Vtheta11. (Generically, if the distance matrix has m rows and n columns, the vertical tilt angle matrix has m−1 rows and n columns.) In the illustrated embodiment, Vtheta0 is the calculated tilt angle between the distance in cell 0 and the distance in cell 4, Vtheta1 is the calculated tilt angle between the distance in cell 1 and the distance in cell 5, Vtheta2 is the calculated tilt angle between the distance in cell 2 and the distance in cell 6, Vtheta3 is the calculated tilt angle between the distance in cell 3 and the distance in cell 7, Vtheta4 is the calculated tilt angle between the distance in cell 4 and the distance in cell 8, Vtheta5 is the calculated tilt angle between the distance in cell 5 and the distance in cell 9, Vtheta6 is the calculated tilt angle between the distance in cell 6 and the distance in cell 10, Vtheta7 is the calculated tilt angle between the distance in cell 7 and the distance in cell 11, Vtheta8 is the calculated tilt angle between the distance in cell 8 and the distance in cell 12, Vtheta9 is the calculated tilt angle between the distance in cell 9 and the distance in cell 13, Vtheta10 is the calculated tilt angle between the distance in cell 10 and the distance in cell 14, and Vtheta11 is the calculated tilt angle between the distance in cell 11 and the distance in cell 15.

In various embodiments, the horizontal tilt angle to be used for horizontal tilt angle correction is determined by calculating an average of the plurality of horizontal tilt angles in the horizontal tilt axis matrix. Similarly, the vertical tilt angle to be used for vertical tilt angle correction is determined by calculating an average of the plurality of vertical tilt angles in the vertical tilt axis matrix.

However, in some alternative embodiments, some of the horizontal tilt angles in the horizontal tilt axis matrix are removed (or otherwise ignored) before calculating an average of the plurality of horizontal tilt angles in the horizontal tilt axis matrix. Similarly, in some alternative embodiments, some of the vertical tilt angles in the vertical tilt axis matrix are removed (or otherwise ignored) before calculating an average of the plurality of vertical tilt angles in the vertical tilt axis matrix.

In one such alternative embodiment, a confidence indicator for each distance in the distance matrix is received from the ToF sensor. Such a confidence indicator indicates whether the ToF sensor has confidence in the accuracy of each specific distance. Any suitable mechanism may be used for the provision of this confidence indicator from the ToF sensor. For example, the ToF sensor may send a confidence matrix (not illustrated) in which each cell has a 1 to indicate confidence in the distance value of the corresponding cell of the distance matrix or a 0 to indicate a lack of confidence in the distance value of the corresponding cell of the distance matrix. Any distance in the distance matrix for which the confidence indicator indicates a lack of confidence is not used when calculating any of the plurality of horizontal tilt angles, any of the plurality of vertical tilt angles, the average of the plurality of horizontal tilt angles in the horizontal tilt axis matrix, or the average of the plurality of vertical tilt angles in the vertical tilt axis matrix.

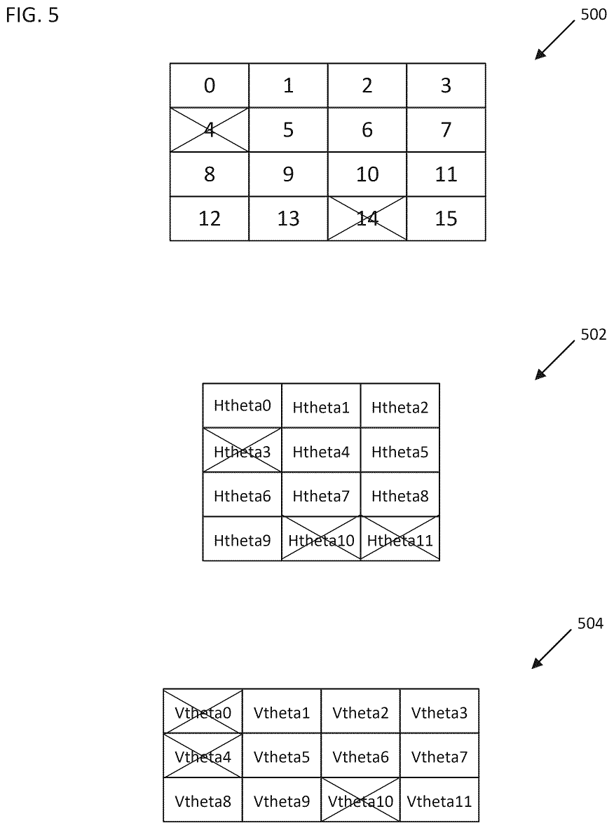

FIG. 5 illustrates an example distance matrix 500 in which two distances—those in cell 4 and in cell 14—are crossed out to indicate a lack of confidence in those two distance values. As such, those two values are not used when calculating the horizontal tilt angles or the vertical tilt angles. This results in there being no values in the horizontal tilt angle matrix 502 for Htheta3 (which would be calculated using the distance value in cell 4) and for Htheta10 and Htheta11 (which would be calculated using the distance value in cell 14) (indicated by these cells being crossed out), and no values in the vertical tilt angle matrix 504 for Vtheta0 and Vtheta4 (which would be calculated using the distance value in cell 4) and for Vtheta10 (which would be calculated using the distance value in cell 14) (indicated by these cells being crossed out). Accordingly, Htheta3, Htheta10, and Htheta11 are not used in calculating the average of the plurality of horizontal tilt angles and Vtheta0, Vtheta4, and Vtheta10 are not used in calculating the average of the plurality of vertical tilt angles.

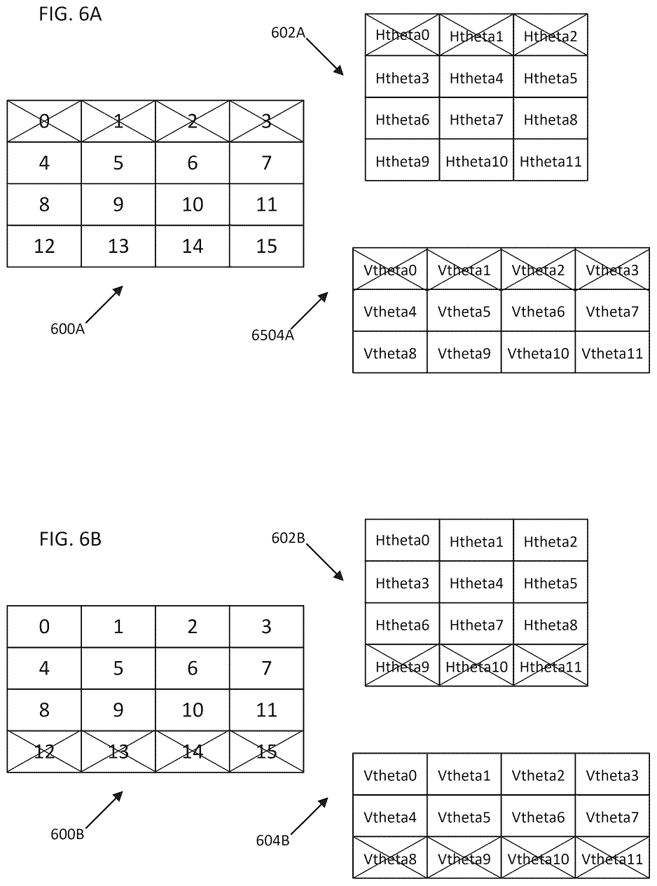

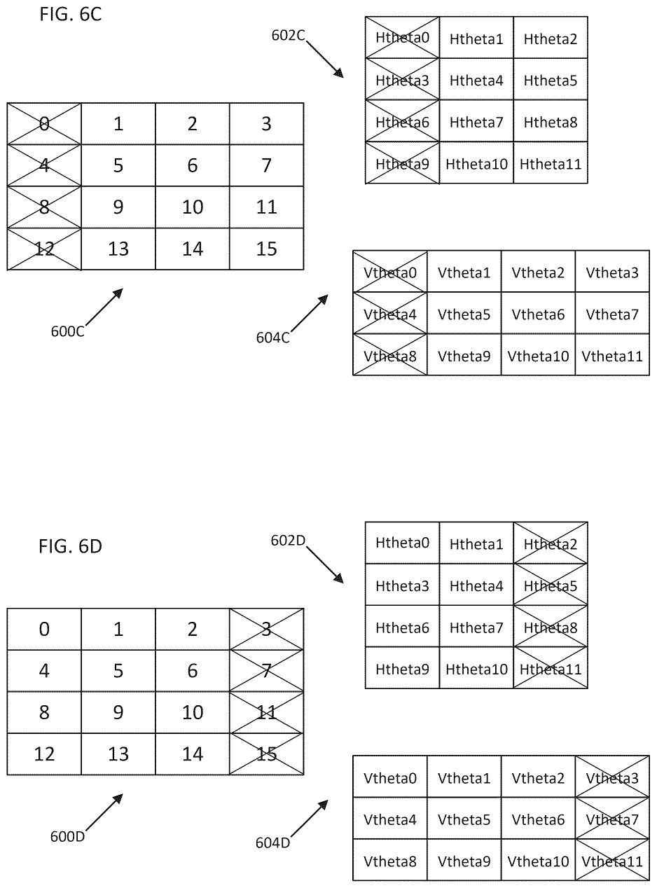

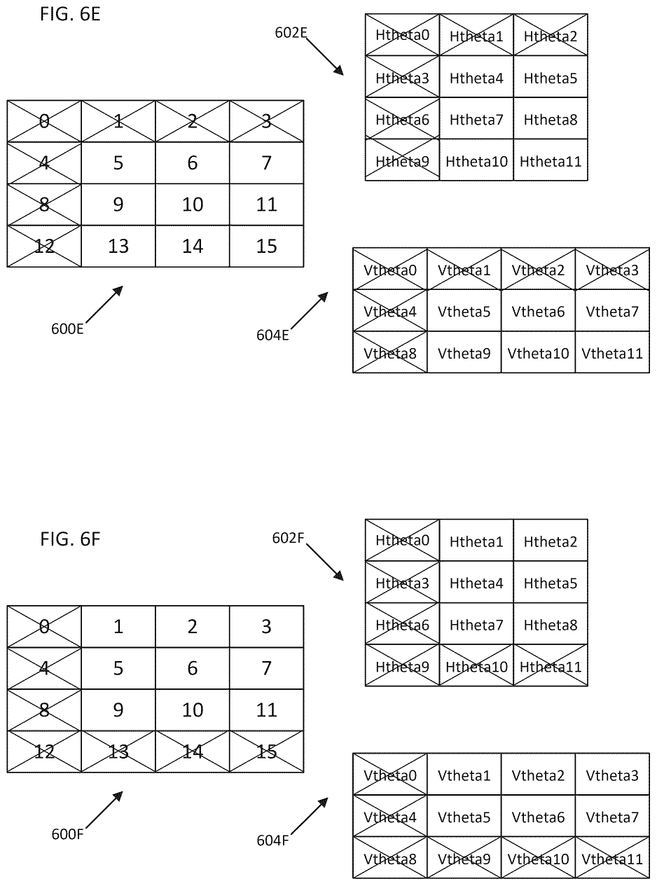

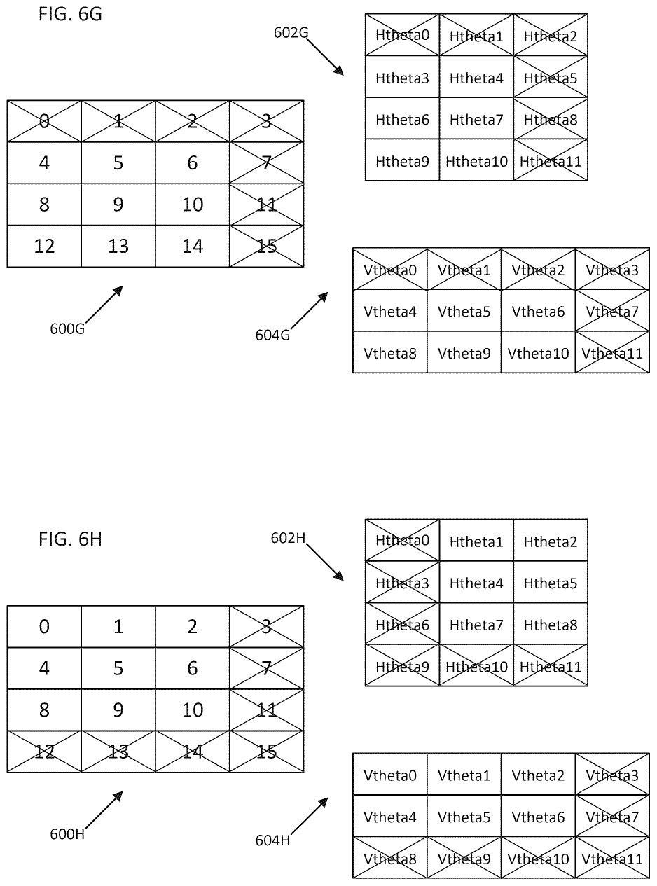

When the projector is tilted upward, the distance values in the top row of the distance matrix (i.e., cells 0, 1, 2, 3) would be the greatest, and therefore the least accurate, distances. Thus, in various embodiments, when an upward tilt is detected by determining that the distance values in the top row of zones are the greatest, then the top row of thetas in both the horizontal and vertical theta maps are eliminated. Eliminating this row of cells provides a more accurate overall horizontal tilt angle and overall vertical tilt angle. As seen in FIG. 6A, the top row of cells in the distance matrix 600A are not used (indicated by these cells being crossed out), and therefore the top row of cells in the horizontal tilt angle matrix 602A are not calculated or, if calculated, not used in calculating the average of the plurality of horizontal tilt angles (indicated by these cells being crossed out) and the top row of cells in the vertical tilt angle matrix 604A are not calculated or, if calculated, not used in calculating the average of the plurality of vertical tilt angles (indicated by these cells being crossed out).

Similarly, when the projector is tilted downward, the distance values in the bottom row of the distance matrix (i.e., cells 12, 13, 14, 15) would be the greatest, and therefore the least accurate, distances. Thus, in various embodiments, when a downward tilt is detected by determining that the distance values in the bottom row of zones are the greatest, then the bottom row of thetas in both the horizontal and vertical theta maps are eliminated. Eliminating this row of cells provides a more accurate overall horizontal tilt angle and overall vertical tilt angle. As seen in FIG. 6B, the bottom row of cells in the distance matrix 600B are not used (indicated by these cells being crossed out), and therefore the bottom row of cells in the horizontal tilt angle matrix 602B are not calculated or, if calculated, not used in calculating the average of the plurality of horizontal tilt angles (indicated by these cells being crossed out) and the bottom row of cells in the vertical tilt angle matrix 604B are not calculated or, if calculated, not used in calculating the average of the plurality of vertical tilt angles (indicated by these cells being crossed out).

Similarly, when the projector is tilted leftward, the distance values in the left column of the distance matrix (cells 0, 4, 8, 12) would be the greatest, and therefore the least accurate, distances. Thus, in various embodiments, when a leftward tilt is detected by determining that the distance values in the left column of zones are the greatest, then the left column of thetas in both the horizontal and vertical theta maps are eliminated. Eliminating this column of cells provides a more accurate overall horizontal tilt angle and overall vertical tilt angle. As seen in FIG. 6C, the left column of cells in the distance matrix 600C are not used (indicated by these cells being crossed out), and therefore the left column of cells in the horizontal tilt angle matrix 602C are not calculated or, if calculated, not used in calculating the average of the plurality of horizontal tilt angles (indicated by these cells being crossed out) and the left column of cells in the vertical tilt angle matrix 604C are not calculated or, if calculated, not used in calculating the average of the plurality of vertical tilt angles (indicated by these cells being crossed out).

Similarly, when the projector is tilted rightward, the distance values in the right column of the distance matrix (i.e., cells 3, 7, 11, 15) would be the greatest, and therefore the least accurate, distances. Thus, in various embodiments, when a rightward tilt is detected by determining that the distance values in the right column of zones are the greatest, then the right column of thetas in both the horizontal and vertical theta maps are eliminated. Eliminating this column of cells provides a more accurate overall horizontal tilt angle and overall vertical tilt angle. As seen in FIG. 6D, the right column of cells in the distance matrix 600D are not used (indicated by these cells being crossed out), and therefore the right column of cells in the horizontal tilt angle matrix 602D are not calculated or, if calculated, not used in calculating the average of the plurality of horizontal tilt angles (indicated by these cells being crossed out) and the right column of cells in the vertical tilt angle matrix 604D are not calculated or, if calculated, not used in calculating the average of the plurality of vertical tilt angles (indicated by these cells being crossed out).

The elimination of a row or a column of distances from the distance matrix and from the calculation of the overall horizontal tilt angle and the overall vertical tilt angle (as described above in relation to FIGS. 6A-6D) may be combined if it is determined that the projector is tilted upward and leftward, downward and leftward, upward and rightward, or downward and rightward.

Thus, in various embodiments, when an upward and leftward tilt are both detected by determining that the distance values in the top row and the left column of zones are the greatest, then the top row of thetas and the left column of thetas in both the horizontal and vertical theta maps are eliminated. This is illustrated in FIG. 6E by the crossing out of the top row and the left column of cells in the distance matrix 600E, the horizontal tilt angle matrix 602E, and the vertical tilt angle matrix 604E.

Similarly, in various embodiments, when a downward and leftward tilt are both detected by determining that the distance values in the bottom row and the left column of zones are the greatest, then the bottom row of thetas and the left column of thetas in both the horizontal and vertical theta maps are eliminated. This is illustrated in FIG. 6F by the crossing out of the bottom row and the left column of cells in the distance matrix 600F, the horizontal tilt angle matrix 602F, and the vertical tilt angle matrix 604F.

Similarly, in various embodiments, when an upward and rightward tilt are both detected by determining that the distance values in the top row and the right column of zones are the greatest, then the top row of thetas and the right column of thetas in both the horizontal and vertical theta maps are eliminated. This is illustrated in FIG. 6G by the crossing out of the top row and the right column of cells in the distance matrix 600G, the horizontal tilt angle matrix 602G, and the vertical tilt angle matrix 604G.

Similarly, in various embodiments, when a downward and rightward tilt are both detected by determining that the distance values in the bottom row and the right column of zones are the greatest, then the bottom row of thetas and the right column of thetas in both the horizontal and vertical theta maps are eliminated. This is illustrated in FIG. 6H by the crossing out of the bottom row and the right column of cells in the distance matrix 600H, the horizontal tilt angle matrix 602H, and the vertical tilt angle matrix 604H.

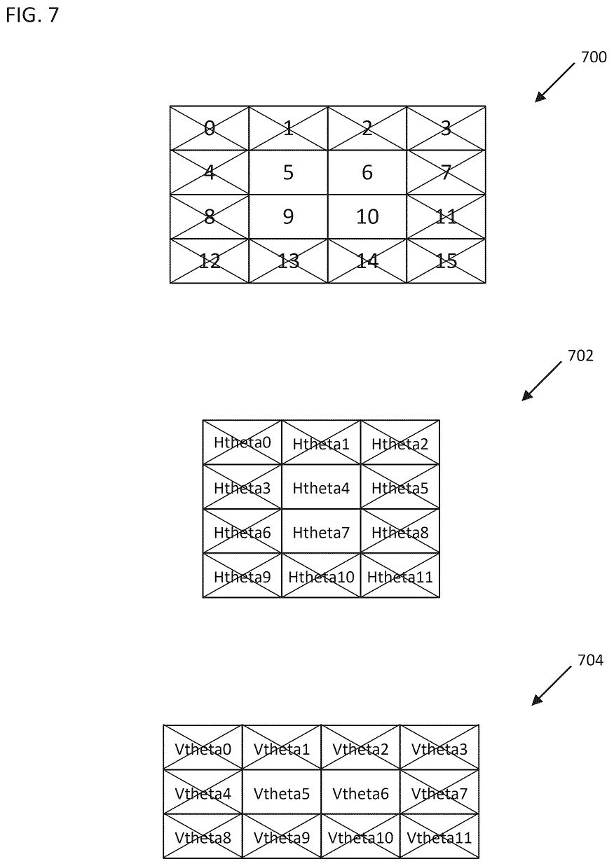

If the projector is tilting only a small amount (e.g., within +/−five degrees of horizontal and/or within +/−five degrees of vertical), the determined overall horizontal tilt angle and/or overall vertical tilt angle may be more accurate if only the distances determined by the ToF sensor that fall within center zones are used to tilt angle determination. Thus, as illustrated in FIG. 7, in various embodiments, if the overall horizontal tilt angle is determined to be within a predetermined distance from zero degrees (e.g., within +/−five degrees of horizontal), then the process is repeated but only the distance values in the center zones (i.e., cells 5, 6, 9, 10) of the distance matrix 700 are used to create the horizontal tilt angle matrix 702. As such, only two cells of the horizontal tilt angle matrix 702 (i.e., cells Htheta4 and Htheta7) are averaged to calculate the overall horizontal tilt angle.

Similarly, if the overall vertical tilt angle is determined to be within a predetermined distance from zero degrees (e.g., within +/−five degrees of vertical), then the process is repeated but only the distance values in the center zones (i.e., cells 5, 6, 9, 10) of the distance matrix 700 are used to create the vertical tilt angle matrix 704. As such, only two cells of the vertical tilt angle matrix 704 (i.e., cells Vtheta5 and Vtheta6) are averaged to calculate the overall vertical tilt angle. By repeating the determination of the overall horizontal tilt angle and/or the overall vertical tilt angle using only the distance values from the center zones, the overall horizontal tilt angle and/or the overall vertical tilt angle are likely to be more accurate.

In various embodiments, if the overall horizontal tilt angle is within the predetermined distance from zero degrees but the overall vertical tilt angle is not, then the distance within the center zones will be used to determine the overall horizontal tilt angle in the repeated process but the process of determining the overall vertical tilt angle will not be repeated. Similarly, if the overall vertical tilt angle is within the predetermined distance from zero degrees but the overall horizontal tilt angle is not, then the distance within the center zones will be used to determine the overall vertical tilt angle in the repeated process but the process of determining the overall horizontal tilt angle will not be repeated.

In various embodiments, the predetermined distance from zero degrees may be the same for both the horizontal and vertical tilt angles or there may be different predetermined distances from zero degrees for the horizontal tilt angle and the vertical tilt angle.

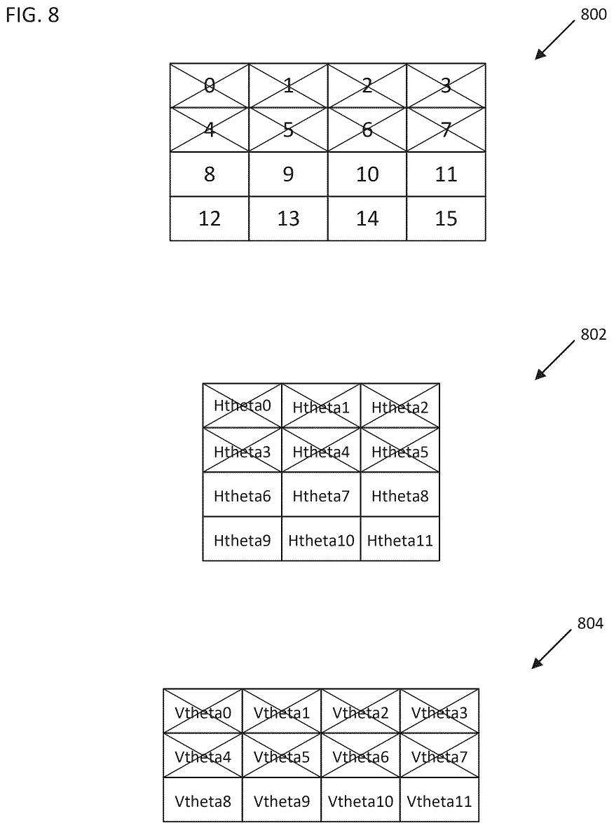

Different projectors may have different power levels, and higher power projectors may be designed to project images farther that lower power projectors. Because a higher power projector is projecting farther, the projected image will be relatively larger and therefore the top part of the image may be more likely to be projected onto a ceiling instead of a wall. The part of the image projected onto the ceiling will be distorted, and the top row or top two rows of distances determined by the ToF sensor may be unreliable. As such, in various embodiments, for a projector that is of such a power level that it is more likely to project its images onto a ceiling, the top row or top two rows of distances determined by the ToF sensor will be eliminated and not used when calculating any of the plurality of horizontal tilt angles, any of the plurality of vertical tilt angles, the average of the plurality of horizontal tilt angles in the horizontal tilt axis matrix, or the average of the plurality of vertical tilt angles in the vertical tilt axis matrix. This is illustrated in FIG. 8 by the crossing out of the top two rows of cells in the distance matrix 800, the horizontal tilt angle matrix 802, and the vertical tilt angle matrix 804.

As the perpendicular distance (i.e., not the distance measured by the ToF, which will often be longer than the perpendicular distance because of the tilt angle) between the projector and the projection surface increases, the field of illumination (FOI) can shrink because photons on the edges of the FOI can get lost. This smaller FOI reduces the angle between the adjacent beams of laser light and therefore reduces the bisected value α that is used to calculate the theta (as described above). To compensate for this change in the bisected value α, a gain coefficient is determined experimentally for each specific model of projector (or for each specific model of ToF sensor used in a particular model of projector) to compensate for this smaller FOI and change in the bisected value α. In various embodiments, multiple values of the gain coefficient are determined experimentally for a variety of different ranges of perpendicular distances. The multiple values of the gain coefficient are stored in a memory of the projector. To determine the multiple values of the gain coefficient, the projector is positioned at a variety of different distances from the projection surface, the overall horizontal tilt angle and the overall vertical tilt angle are determined by the process described herein and then compared to actual measured values of the overall horizontal tilt angle and the overall vertical tilt angle. Multiple values of the gain coefficient are selected that can be multiplied by the overall horizontal tilt angle and the overall vertical tilt angle as determined by the process described herein to arrive at the actual measured values.

When executing the process of determining the overall horizontal tilt angle and/or the overall vertical tilt angle to be used for keystone correction as described herein, an approximate perpendicular distance between the projector and the projection surface is determined. In various embodiments, the approximate perpendicular distance is calculated as cos (theta)×distance determined by ToF sensor. Based on the determined approximate perpendicular distance, an appropriate gain coefficient is retrieved from memory and the overall horizontal tilt angle and the overall vertical tilt angle as determined by the process described herein are multiplied by the appropriate gain coefficient to calculate adjusted values for the overall horizontal tilt angle and the overall vertical tilt angle. In various embodiments, it is these adjusted values for the overall horizontal tilt angle and the overall vertical tilt angle that are used for keystone correction.

In various embodiments, the process of determining the overall horizontal tilt angle and/or the overall vertical tilt angle to be used for keystone correction may be executed once upon startup of the projector or may be executed continuously while the projector is operating (although this latter option is more resource intensive). In various other embodiments, the projector may comprise a motion sensor and the process of determining the overall horizontal tilt angle and/or the overall vertical tilt angle to be used for keystone correction may be executed any time the projection is operating and motion has been detected (i.e., thereby indicating that the projector may have been moved (e.g., bumped) and therefore the tilt angles may have changed). In various embodiments, the process may be repeated only if the detected motion exceeds a predetermined threshold such that minor movement of the projector does not cause the process to be repeated.

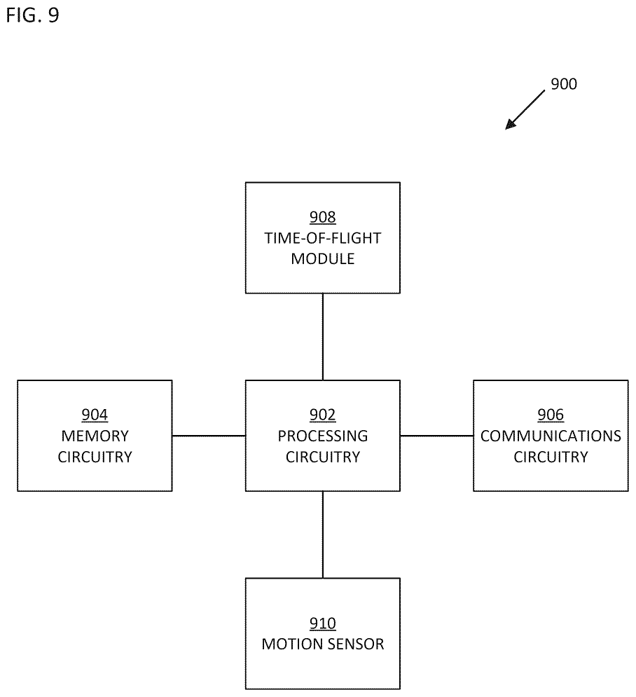

FIG. 9 illustrates an exemplary block diagram of an example device that may be specially configured in accordance with an example embodiment of the present disclosure. Specifically, FIG. 9 depicts an example projector 900 specially configured in accordance with at least some example embodiments of the present disclosure. The projector 900 of FIG. 9 comprises processing circuitry 902, memory circuitry 904, communications circuitry 906, a ToF sensor 908, and a motion sensor 910. In some embodiments, the projector 900 is configured to execute and perform the operations described herein. For example, the projector 900 may be configured to implement a method for determining the overall horizontal tilt angle and/or the overall vertical tilt angle to be used for keystone correction as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

Processing circuitry 902 may be embodied in a number of different ways. In various embodiments, the use of the terms “processor,” “processing circuitry,” “controller,” or “control circuitry” should be understood to include a single core processor, a multi-core processor, multiple processors internal to the projector 900, and/or one or more remote or “cloud” processor(s) external to the projector 900. In some example embodiments, processing circuitry 902 may include one or more processing devices configured to perform independently. Alternatively, or additionally, processing circuitry 902 may include one or more processor(s) configured in tandem via a bus to enable independent execution of operations, instructions, pipelining, and/or multithreading.

In an example embodiment, the processing circuitry 902 may be configured to execute instructions stored in the memory circuitry 904 or otherwise accessible to the processor. Alternatively, or additionally, the processing circuitry 902 may be configured to execute hard-coded functionality. As such, whether configured by hardware or software methods, or by a combination thereof, processing circuitry 902 may represent an entity (e.g., physically embodied in circuitry) capable of performing operations according to embodiments of the present disclosure while configured accordingly. Alternatively, or additionally, processing circuitry 902 may be embodied as an executor of software instructions, and the instructions may specifically configure the processing circuitry 902 to perform the various algorithms embodied in one or more operations described herein when such instructions are executed. In some embodiments, the processing circuitry 902 includes hardware, software, firmware, and/or a combination thereof that performs one or more operations described herein.

In some embodiments, the processing circuitry 902 (and/or co-processor or any other processing circuitry assisting or otherwise associated with the processor) is/are in communication with the memory circuitry 904 via a bus for passing information among components of the projector 900.

Memory or memory circuitry 904 may be non-transitory and may include, for example, one or more volatile and/or non-volatile memories. In some embodiments, the memory circuitry 904 includes or embodies an electronic storage device (e.g., a computer readable storage medium). In some embodiments, the memory circuitry 904 is configured to store information, data, content, applications, instructions, or the like, for enabling a projector 900 to carry out various operations and/or functions in accordance with example embodiments of the present disclosure.

Communications circuitry 906 may be included in the projector 900. The communications circuitry 906 may include any means such as a device or circuitry embodied in either hardware or a combination of hardware and software that is configured to receive and/or transmit data from/to a network and/or any other device, circuitry, or module in communication with the projector 900. In some embodiments the communications circuitry 906 includes, for example, a network interface for enabling communications with a wired or wireless communications network. Additionally or alternatively, the communications circuitry 906 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 906 may include circuitry for interacting with an antenna(s) and/or other hardware or software to cause transmission of signals via the antenna(s) and/or to handle receipt of signals received via the antenna(s). In some embodiments, the communications circuitry 906 enables transmission to and/or receipt of data from a user device, one or more sensors, and/or other external computing device(s) in communication with the projector 900.

The multi-zone ToF sensor 908 is included in the projector 900 for determining a plurality of distances between the projector 900 and a projection surface as described above.

The motion sensor 910 may be included in the projector 900 for sensing movement of the projector 900 to cause the process described herein to be repeated as described above.

Various methods described herein may provide various technical benefits and improvements. It is noted that processes described herein may be implemented by various means such as hardware, firmware, circuitry and/or other devices associated with execution of software including one or more computer program instructions. For example, one or more of the procedures described herein may be embodied by computer program instructions, which may be stored by a non-transitory memory of an apparatus employing an embodiment of the present disclosure and executed by a processor in the apparatus. These computer program instructions may direct a computer or other programmable apparatus to function in a particular manner, such that the instructions stored in the computer-readable storage memory produce an article of manufacture, the execution of which implements the function specified in the flowchart block(s).

As described above and as will be appreciated based on this disclosure, embodiments of the present disclosure may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

### CONCLUSION

Many modifications and other embodiments of the disclosures set forth herein will come to mind to one skilled in the art to which these disclosures pertain having the benefit of teachings presented in the foregoing descriptions and the associated drawings. Although the figures only show certain components of the apparatus and systems described herein, it is understood that various other components may be used in conjunction with the system. Therefore, it is to be understood that the disclosures are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. The disclosed embodiments relate primarily to fragmented wideband tympanometry techniques for true wireless stereo, however, one skilled in the art may recognize that such principles may be applied to any audio device. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the disclosure(s) set out in any claims that may issue from this disclosure.

While this detailed description has set forth some embodiments of the present disclosure, the appended claims cover other embodiments of the present disclosure which differ from the described embodiments according to various modifications and improvements. For example, the appended claims can cover any form of device which uses a ToF sensor and needs a relatively accurate tilt angle determination, such as but not limited to projectors and robotics applications.

Within the appended claims, unless the specific term “means for” or “step for” is used within a given claim, it is not intended that the claim be interpreted under 35 U.S.C. 112, paragraph 6.

What is claimed is:

1. A device comprising:
a time-of-flight (Tof) sensor for determining a distance from the ToF sensor to a surface for a plurality of different zones arranged in a distance matrix of m rows and n columns; and
a controller configured to (i) receive the distance matrix from the ToF sensor, (ii) create a horizontal tilt axis matrix of m rows and (n−1) columns, where each row of the horizontal tilt axis matrix comprises a plurality of horizontal tilt angles, each calculated using two adjacent distances in a corresponding row of the distance matrix, (iii) create a vertical tilt axis matrix of (m−1) rows and n columns, where each column of the vertical tilt axis matrix comprises a plurality of vertical tilt angles, each calculated using two adjacent distances in a corresponding column of the distance matrix, (iv) calculate an average of the plurality of horizontal tilt angles in the horizontal tilt axis matrix to be used for horizontal tilt angle correction, and (v) calculate an average of the plurality of vertical tilt angles in the vertical tilt axis matrix to be used for vertical tilt angle correction.

2. The device of claim 1, wherein the controller is further configured to receive a confidence indicator for each distance in the distance matrix; and
wherein the controller does not use any distance in the distance matrix for which the confidence indicator indicates a lack of confidence when calculating any of the plurality of horizontal tilt angles, any of the plurality of vertical tilt angles, the average of the plurality of horizontal tilt angles in the horizontal tilt axis matrix, or the average of the plurality of vertical tilt angles in the vertical tilt axis matrix.

3. The device of claim 1, wherein, if the distance in a leftmost cell of each row of the distance matrix is greater than the distance in every other cell in a same row of the distance matrix, the controller does not use any distances in a leftmost column of the distance matrix when calculating any of the plurality of horizontal tilt angles, any of the plurality of vertical tilt angles, the average of the plurality of horizontal tilt angles in the horizontal tilt axis matrix, or the average of the plurality of vertical tilt angles in the vertical tilt axis matrix;
wherein, if the distance in a rightmost cell of each row of the distance matrix is greater than the distance in every other cell in a same row of the distance matrix, the controller does not use any distances in a rightmost column of the distance matrix when calculating any of the plurality of horizontal tilt angles, any of the plurality of vertical tilt angles, the average of the plurality of horizontal tilt angles in the horizontal tilt axis matrix, or the average of the plurality of vertical tilt angles in the vertical tilt axis matrix;
wherein, if the distance in a topmost cell of each column of the distance matrix is greater than the distance in every other cell in a same column of the distance matrix, the controller does not use any distances in a topmost row of the distance matrix when calculating any of the plurality of horizontal tilt angles, any of the plurality of vertical tilt angles, the average of the plurality of horizontal tilt angles in the horizontal tilt axis matrix, or the average of the plurality of vertical tilt angles in the vertical tilt axis matrix; and/or
wherein, if the distance in a bottommost cell of each column of the distance matrix is greater than the distance in every other cell in a same column of the distance matrix, the controller does not use any distances in a bottommost row of the distance matrix when calculating any of the plurality of horizontal tilt angles, any of the plurality of vertical tilt angles, the average of the plurality of horizontal tilt angles in the horizontal tilt axis matrix, or the average of the plurality of vertical tilt angles in the vertical tilt axis matrix.

4. The device of claim 1, wherein the controller does not use any distances in a topmost row or in the two topmost rows of the distance matrix when calculating any of the plurality of horizontal tilt angles, any of the plurality of vertical tilt angles, the average of the plurality of horizontal tilt angles in the horizontal tilt axis matrix, or the average of the plurality of vertical tilt angles in the vertical tilt axis matrix.

5. The device of claim 1, wherein the controller is further configured to determine if the average of the plurality of horizontal tilt angles in the horizontal tilt axis matrix is within a predefined range of zero degrees;
wherein, if the average of the plurality of horizontal tilt angles in the horizontal tilt axis matrix is within the predefined range of zero degrees, the controller is further configured to recalculate the average of the plurality of horizontal tilt angles in the horizontal tilt axis matrix without using any distance in peripheral cells of the distance matrix;
wherein the controller is further configured to determine if the average of the plurality of vertical tilt angles in the vertical tilt axis matrix is within a predefined range of zero degrees; and
wherein, if the average of the plurality of vertical tilt angles in the vertical tilt axis matrix is within the predefined range of zero degrees, the controller is further configured to recalculate the average of the plurality of vertical tilt angles in the vertical tilt axis matrix without using any distance in peripheral cells of the distance matrix.

6. The device of claim 1, wherein the controller is further configured to determine an estimated perpendicular distance from the ToF sensor to the surface;
wherein the controller is further configured to determine which one of a plurality of predetermined gain coefficients corresponds to the determined estimated perpendicular distance from the ToF sensor to the surface;
wherein the controller is further configured to multiply the calculated average of the plurality of horizontal tilt angles in the horizontal tilt axis matrix by the one of the plurality of predetermined gain coefficients; and
wherein the controller is further configured to multiply the calculated average of the plurality of vertical tilt angles in the vertical tilt axis matrix by the one of the plurality of predetermined gain coefficients.

7. The device of claim 1, wherein the Tof sensor determines the distance from the ToF sensor to the surface for the plurality of different zones and the controller (i) receives the distance matrix from the ToF sensor, (ii) creates the horizontal tilt axis matrix, (iii) creates the vertical tilt axis matrix, (iv) calculates the average of the plurality of horizontal tilt angles in the horizontal tilt axis matrix, and (v) calculates the average of the plurality of vertical tilt angles in the vertical tilt axis matrix upon startup of the device.

8. The device of claim 7, further comprising a motion sensor configured to detect movement of the device;
wherein, upon detection of movement by the motion sensor, the Tof sensor is further configured to determine a revised distance from the ToF sensor to the surface for the plurality of different zones and the controller is further configured to (i) receive a revised distance matrix from the ToF sensor, (ii) create a revised horizontal tilt axis matrix of m rows and (n−1) columns, where each row of the horizontal tilt axis matrix comprises a plurality of horizontal tilt angles, each calculated using two adjacent distances in a corresponding row of the distance matrix, (iii) create a revised vertical tilt axis matrix of (m−1) rows and n columns, where each column of the vertical tilt axis matrix comprises a plurality of vertical tilt angles, each calculated using two adjacent distances in a corresponding column of the distance matrix, (iv) calculate a revised average of the plurality of horizontal tilt angles in the horizontal tilt axis matrix to be used for horizontal tilt angle correction, and (v) calculate a revised average of the plurality of vertical tilt angles in the vertical tilt axis matrix to be used for vertical tilt angle correction.

9. The device of claim 7, wherein the Tof sensor determines the distance from the ToF sensor to the surface for the plurality of different zones and the controller (i) receives the distance matrix from the ToF sensor, (ii) creates the horizontal tilt axis matrix, (iii) creates the vertical tilt axis matrix, (iv) calculates the average of the plurality of horizontal tilt angles in the horizontal tilt axis matrix, and (v) calculates the average of the plurality of vertical tilt angles in the vertical tilt axis matrix repeatedly during operation of the device.

10. The device of claim 1, wherein the device comprises a projector.

11. A method of determining a tilt angle of a device having a time-of-flight (Tof) sensor, the method comprising:
receiving a distance matrix from the ToF sensor, the distance matrix comprising a distance from the ToF sensor to a surface for a plurality of different zones arranged in the distance matrix of m rows and n columns;
creating a horizontal tilt axis matrix of m rows and (n−1) columns, where each row of the horizontal tilt axis matrix comprises a plurality of horizontal tilt angles, each calculated using two adjacent distances in a corresponding row of the distance matrix;
creating a vertical tilt axis matrix of (m−1) rows and n columns, where each column of the vertical tilt axis matrix comprises a plurality of vertical tilt angles, each calculated using two adjacent distances in a corresponding column of the distance matrix;
calculating an average of the plurality of horizontal tilt angles in the horizontal tilt axis matrix to be used for horizontal tilt angle correction; and
calculating an average of the plurality of vertical tilt angles in the vertical tilt axis matrix to be used for vertical tilt angle correction.

12. The method of claim 11, further comprising:
receiving, from the ToF sensor, a confidence indicator for each distance in the distance matrix; and
wherein any distance in the distance matrix for which the confidence indicator indicates a lack of confidence is not used when calculating any of the plurality of horizontal tilt angles, any of the plurality of vertical tilt angles, the average of the plurality of horizontal tilt angles in the horizontal tilt axis matrix, or the average of the plurality of vertical tilt angles in the vertical tilt axis matrix.

13. The method of claim 11, wherein, if the distance in a leftmost cell of each row of the distance matrix is greater than the distance in every other cell in a same row of the distance matrix, any distances in a leftmost column of the distance matrix are not used when calculating any of the plurality of horizontal tilt angles, any of the plurality of vertical tilt angles, the average of the plurality of horizontal tilt angles in the horizontal tilt axis matrix, or the average of the plurality of vertical tilt angles in the vertical tilt axis matrix;
wherein, if the distance in a rightmost cell of each row of the distance matrix is greater than the distance in every other cell in a same row of the distance matrix, any distances in a rightmost column of the distance matrix are not used when calculating any of the plurality of horizontal tilt angles, any of the plurality of vertical tilt angles, the average of the plurality of horizontal tilt angles in the horizontal tilt axis matrix, or the average of the plurality of vertical tilt angles in the vertical tilt axis matrix;
wherein, if the distance in a topmost cell of each column of the distance matrix is greater than the distance in every other cell in a same column of the distance matrix, any distances in a topmost row of the distance matrix are not used when calculating any of the plurality of horizontal tilt angles, any of the plurality of vertical tilt angles, the average of the plurality of horizontal tilt angles in the horizontal tilt axis matrix, or the average of the plurality of vertical tilt angles in the vertical tilt axis matrix; and/or
wherein, if the distance in a bottommost cell of each column of the distance matrix is greater than the distance in every other cell in a same column of the distance matrix, any distances in a bottommost row of the distance matrix are not used when calculating any of the plurality of horizontal tilt angles, any of the plurality of vertical tilt angles, the average of the plurality of horizontal tilt angles in the horizontal tilt axis matrix, or the average of the plurality of vertical tilt angles in the vertical tilt axis matrix.

14. The method of claim 11, wherein any distances in a topmost row or in the two topmost rows of the distance matrix are not used when calculating any of the plurality of horizontal tilt angles, any of the plurality of vertical tilt angles, the average of the plurality of horizontal tilt angles in the horizontal tilt axis matrix, or the average of the plurality of vertical tilt angles in the vertical tilt axis matrix.

15. The method of claim 11, further comprising:
determining if the average of the plurality of horizontal tilt angles in the horizontal tilt axis matrix is within a predefined range of zero degrees;
if the average of the plurality of horizontal tilt angles in the horizontal tilt axis matrix is within the predefined range of zero degrees, recalculating the average of the plurality of horizontal tilt angles in the horizontal tilt axis matrix without using any distance in peripheral cells of the distance matrix;
determining if the average of the plurality of vertical tilt angles in the vertical tilt axis matrix is within a predefined range of zero degrees; and
if the average of the plurality of vertical tilt angles in the vertical tilt axis matrix is within the predefined range of zero degrees, recalculating the average of the plurality of vertical tilt angles in the vertical tilt axis matrix without using any distance in peripheral cells of the distance matrix.

16. The method of claim 11, further comprising:
determining an estimated perpendicular distance from the ToF sensor to the surface;
determining which one of a plurality of predetermined gain coefficients corresponds to the determined estimated perpendicular distance from the ToF sensor to the surface;
multiplying the calculated average of the plurality of horizontal tilt angles in the horizontal tilt axis matrix by the one of the plurality of predetermined gain coefficients; and
multiplying the calculated average of the plurality of vertical tilt angles in the vertical tilt axis matrix by the one of the plurality of predetermined gain coefficients.

17. The method of claim 11, wherein receiving the distance matrix from the ToF sensor, creating the horizontal tilt axis matrix, creating the vertical tilt axis matrix, calculating the average of the plurality of horizontal tilt angles in the horizontal tilt axis matrix, and calculating the average of the plurality of vertical tilt angles in the vertical tilt axis matrix occur upon startup of the device.

18. The method of claim 17, wherein the device further comprises a motion sensor configured to detect movement of the device;
wherein, upon detection of movement by the motion sensor, the method further comprises:
receiving a revised distance matrix from the ToF sensor based on revised distances from the ToF sensor to the surface for the plurality of different zones;
creating a revised horizontal tilt axis;
creating a revised vertical tilt axis matrix;
calculating a revised average of the plurality of horizontal tilt angles in the horizontal tilt axis matrix; and
calculating a revised average of the plurality of vertical tilt angles in the vertical tilt axis matrix.

19. The method of claim 17, wherein receiving the distance matrix from the ToF sensor, creating the horizontal tilt axis matrix, creating the vertical tilt axis matrix, calculating the average of the plurality of horizontal tilt angles in the horizontal tilt axis matrix, and calculating the average of the plurality of vertical tilt angles in the vertical tilt axis matrix occur repeatedly during operation of the device.

20. The method of claim 11, wherein the device comprises a projector.
